(19) United States
(12) Patent Application Publication
(10) Pub. No.: US 2026/0197803 A1
(43) Pub. Date: Jul. 9, 2026

(54) ENERGY HARVESTING MOBILE HETEROGENEOUS NETWORK OPTIMIZATION METHOD WITH AGE OF INFORMATION CONSTRAINT

(71) Applicant: Zhejiang University of Technology, Hangzhou (CN)

(72) Inventors: Xiaoying LIU, Hangzhou (CN); Jiaxiang XU, Hangzhou (CN); Kechen ZHENG, Hangzhou (CN)

(21) Appl. No.: 19/403,245

(22) Filed: Nov. 28, 2025

(30) Foreign Application Priority Data
Jan. 7, 2025 (CN) 202510024111.4

(51) Int. Cl. H04W 72/04; G06N 3/092

(52) U.S. Cl. CPC H04W 72/04; G06N 3/092

(57) ABSTRACT

Disclosed is an energy harvesting mobile heterogeneous network optimization method with an age of information constraint, including: establishing the corresponding digital twin layer for a physical entity layer including a base station, a plurality of hybrid access points, a plurality of transmitters, and a plurality of receivers; in the control phase of a time slot, obtaining the corresponding mode selection and channel allocation strategy of the plurality of transmitters through the trained first deep reinforcement learning network; obtaining the power control and energy harvesting time strategy of the plurality of transmitters through the trained second deep reinforcement learning network; sending the strategy to the digital twin layer; combining, by the digital twin layer, the strategies into the complete mode selection and resource allocation strategy, and synchronizing the strategy to the plurality of transmitters to work.

### CROSS-REFERENCE TO RELATED APPLICATIONS

The present disclosure claims priority of Chinese Patent Application No. 202510024111.4, filed on Jan. 7, 2025, the entire contents of which are hereby incorporated by reference.

### TECHNICAL FIELD

The present disclosure relates to the technical fields of wireless transmission, and in particular to an energy harvesting mobile heterogeneous network optimization method with an age of information constraint.

### BACKGROUND

With the rapid development of the internet of things and communication technologies, the number of devices and data traffic are explosively growing in emerging applications and service scenarios such as smart cities and autonomous driving. The energy limitations of these devices are non-negligible. When a large number of devices are deployed at locations unsuitable for battery charging and replacement, their limited lifespan degrades network performance. To meet the ever-increasing data traffic demands of emerging wireless communication services while providing high-quality services for devices, new technologies are needed to improve network performance.

On the one hand, one method to improve network performance is to adopt a heterogeneous network architecture. By deploying multiple small base stations within the coverage area of a macro base station, data traffic and network performance are further improved. Furthermore, to increase the energy supply of devices, devices employ radio frequency (RF) signal-based wireless energy transfer technology, allowing devices in the network to harvest energy from RF signals and store it in their batteries. Additionally, device-to-device (D2D) communication mode enables nearby devices to communicate directly without relays. Due to the shorter transmission distance, devices can use lower transmission power, reducing interference to other devices and improving network performance.

On the other hand, real-time applications and services in the network have strict requirements on data latency. Data arriving at its destination is required to be as fresh as possible. Age of information (AoI) measures data freshness and is defined as the time elapsed since the data most recently received by the destination was generated. Therefore, efficient mode selection and resource allocation are crucial for improving the long-term total throughput of the internet while satisfying the AoI constraint of devices.

To address the challenges of long-term performance optimization and device mobility in the energy harvesting mobile heterogeneous network, while satisfying the AoI constraint of devices, implementing efficient mode selection and resource allocation is essential. In dynamic and complex network scenarios with limited network resources, achieving efficient mode selection and resource allocation to improve the long-term total throughput of the internet while satisfying the AoI constraint of devices is of great significance.

### SUMMARY

The objective of the present disclosure is to provide an energy harvesting mobile heterogeneous network optimization method with an age of information constraint, enabling devices to rationally select modes and utilize limited network resources in dynamic and complex networks to improve the long-term total throughput of the energy harvesting mobile heterogeneous network, while satisfying the AoI constraint of devices.

In order to achieve the aforementioned objective, the present disclosure provides an energy harvesting mobile heterogeneous network optimization method with an age of information constraint, including:
establishing a corresponding digital twin layer for a physical entity layer comprising a base station, a plurality of hybrid access points, a plurality of transmitters, and a plurality of receivers;
in a control phase of a time slot, moving the plurality of transmitters and the plurality of receivers; inputting, by the plurality of transmitters, local state information into a trained first deep reinforcement learning network to obtain a corresponding mode selection and channel allocation strategy; and sending the corresponding mode selection and channel allocation strategy to the digital twin layer;
inputting, by the base station, global state information and the mode selection and channel allocation strategy of the plurality of transmitters into a trained second deep reinforcement learning network to obtain a power control and energy harvesting time strategy of the plurality of transmitters, and sending the power control and energy harvesting time strategy to the digital twin layer;
combining, by the digital twin layer, the mode selection and channel allocation strategy of the plurality of transmitters with the power control and energy harvesting time strategy of the plurality of transmitters into a complete mode selection and resource allocation strategy, and synchronizing the complete mode selection and resource allocation strategy to the plurality of transmitters;
in a wireless energy transfer phase, performing, by the plurality of transmitters, energy harvesting according to an energy harvesting time; and in a wireless data transmission phase, performing, by the plurality of transmitters, data transmission according to a mode selection, a channel allocation, and a power control.

In some embodiments, the digital twin layer is deployed at the base station.

In some embodiments, the local state information includes:
a position coordinate of a corresponding transmitter after movement in a current time slot; a position coordinate of a corresponding receiver after movement in the current time slot; a ratio of available energy to a battery capacity of the corresponding transmitter at a beginning of the current time slot; an age of information of the corresponding transmitter in the current time slot; a binary variable indicating whether the corresponding transmitter generates data in the current time slot; a channel gain between the corresponding transmitter after movement and an associated base station or an associated hybrid access point in the current time slot; a channel gain between the corresponding transmitter after movement and the corresponding receiver after movement in the current time slot; a throughput of the plurality of transmitters in a previous time slot; and a channel allocation of the plurality of transmitters in the previous time slot.

In some embodiments, the global state information includes:
a ratio of available energy to a battery capacity of the plurality of transmitters at a beginning of a current time slot; an age of information of the plurality of transmitters in the current time slot; and a throughput of the plurality of transmitters in a previous time slot.

In some embodiments, the energy harvesting mobile heterogeneous network optimization method with the age of information constraint further includes a step of:
training the first deep reinforcement learning network and the second deep reinforcement learning network.

The step of training the first deep reinforcement learning network and the second deep reinforcement learning network includes steps of:
step F1: initializing a local Q-network and a target Q-network corresponding to the first deep reinforcement learning network; and initializing parameters of a current actor network, a target actor network, a first current critic network, a first target critic network, a second current critic network, and a second target critic network corresponding to the second deep reinforcement learning network;
step F2: initializing the plurality of hybrid access points, the plurality of transmitters, and the plurality of receivers;
step F3: moving the plurality of transmitters and the plurality of receivers; and updating the local state information of a current time slot in the digital twin layer;
step F4: sending, by the plurality of transmitters, the local state information to the local Q-network to obtain the corresponding mode selection and channel allocation strategy; and sending the mode selection and channel allocation strategy to the digital twin layer;
step F5: receiving, by the base station, the global state information in the digital twin layer and the mode selection and channel allocation strategy of the plurality of transmitters; inputting the global state information and the mode selection and channel allocation strategy into the current actor network to obtain the power control and energy harvesting time strategy of the plurality of transmitters; and sending the power control and energy harvesting time strategy to the digital twin layer;
step F6: combining, by the digital twin layer, the mode selection and channel allocation strategy of the plurality of transmitters with the power control and energy harvesting time strategy of the plurality of transmitters into the complete mode selection and resource allocation strategy, and synchronizing the mode selection and resource allocation strategy to the plurality of transmitters;
step F7: executing, by the plurality of transmitters, the complete mode selection and resource allocation strategy;
step F8: calculating respectively, by the plurality of transmitters and the base station, corresponding rewards;
step F9: storing respectively, by the plurality of transmitters and the base station, experiences of the plurality of transmitters and the base station into respective experience replay pools; and sampling randomly, by the plurality of transmitters and the base station, a preset number of experiences;
step F10: updating, by the plurality of transmitters, a parameter of the local Q-network based on sampled experiences;
step F11: performing a null operation when a current iteration number modulo 2 is not equal to zero; otherwise, updating a parameter of the target Q-network using the parameter of the local Q-network;
step F12: updating, by the base station, the parameters of the first and second current critic networks based on sampled experiences;
step F13: performing the null operation when the current iteration number modulo 2 is not equal to zero; otherwise, updating the parameters of the current actor network and all the target networks based on the sampled experiences;
step F14: setting a next time slot as the current time slot and returning to the step F3 when a current time slot number is less than a total number of time slots; and
step F15: returning to the step F2 to continue iterative training when a current iteration number is less than a total iteration number; otherwise, ending the training.

In some embodiments, the experiences of the plurality of transmitters include the local state information of the plurality of transmitters, the mode selection and channel allocation strategy, the reward obtained by the plurality of transmitters, and the local state information of the plurality of transmitters in the next time slot.

In some embodiments, the experiences of the base station include the global state information, the mode selection and channel allocation strategy of the plurality of transmitters, the power control and energy harvesting time strategy of the plurality of transmitters, the reward obtained by the base station, as well as the global state information and the mode selection and channel allocation strategy of the plurality of transmitters in the next time slot.

Compared with existing technologies, the energy harvesting mobile heterogeneous network optimization method with the age of information constraint proposed in the present disclosure has significant advantages:

The present disclosure integrates digital twin technology into the state information exchange and acquisition process during the training of a complex deep reinforcement learning framework. Twin communication between the digital twin layer and the physical entity layer enables more efficient state information exchange and acquisition, as well as the implementation of mode selection and resource allocation in the physical entity layer. To further improve the performance of deep reinforcement learning in output actor and avoid the problem of non-convergence for algorithms caused by the huge state-action space, the present disclosure employs the first deep reinforcement learning to optimize mode selection and channel allocation. However, the first deep reinforcement learning leads to agents competing for limited network resources. To coordinate the actions of the agents, the present disclosure employs a second deep reinforcement learning. By using the global state information and the received output of the first deep reinforcement learning as its own state information, it coordinates the actions of the agents to reduce competition, while simultaneously optimizing power control and wireless energy harvesting time.

The present disclosure achieves reasonable mode selection and resource allocation strategy through deep reinforcement learning and improves the long-term total network throughput through training, while satisfying the AoI constraint of devices.

### BRIEF DESCRIPTION OF DRAWINGS

FIG. 1 is a flow chart of an energy harvesting mobile heterogeneous network optimization method with the age of information constraint according to some embodiments of the present disclosure;

FIG. 2 is a schematic structural view of an energy harvesting mobile heterogeneous network according to some embodiments of the present disclosure; and

FIG. 3 is a schematic structural view of a time slot according to some embodiments of the present disclosure.

### DESCRIPTION OF EMBODIMENTS

To make the objectives, technical solutions, and advantages of the present disclosure clearer, the following provides a more detailed description of the present disclosure in conjunction with the accompanying drawings and exemplary embodiments. It should be understood that the specific embodiments described herein are merely illustrative of the present disclosure and are not intended to limit its scope.

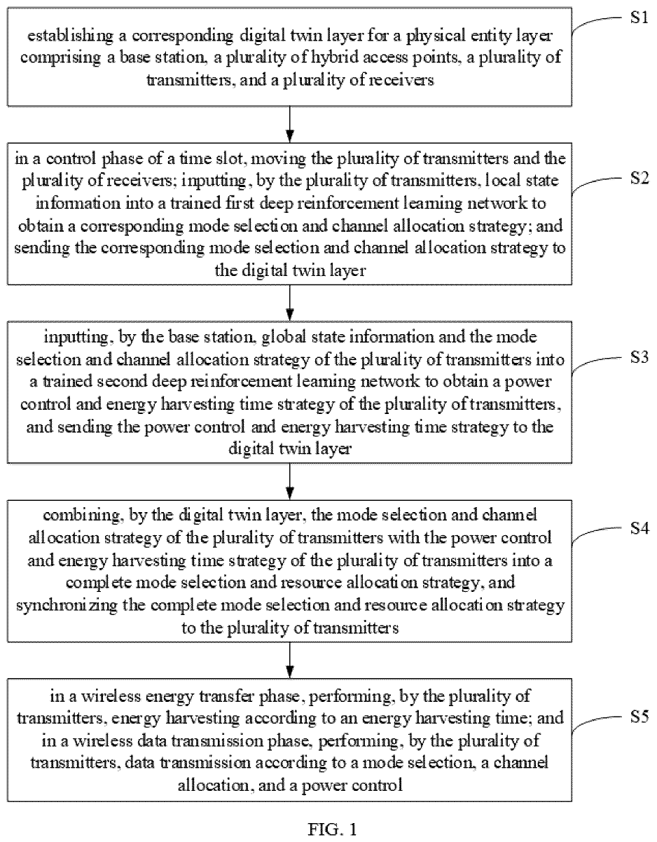

In one embodiment, as shown in FIG. 1, an energy harvesting mobile heterogeneous network optimization method with the age of information (AoI) constraint is provided. By employing deep reinforcement learning, devices select reasonable modes and utilize the limited network resource to maximize the long-term throughput under the AoI constraint of devices in the dynamic and complex network.

The energy harvesting mobile heterogeneous network optimization method with the age of information constraint includes the following steps:

Step S1: establishing a corresponding digital twin layer for a physical entity layer comprising a base station, a plurality of hybrid access points, a plurality of transmitters, and a plurality of receivers.

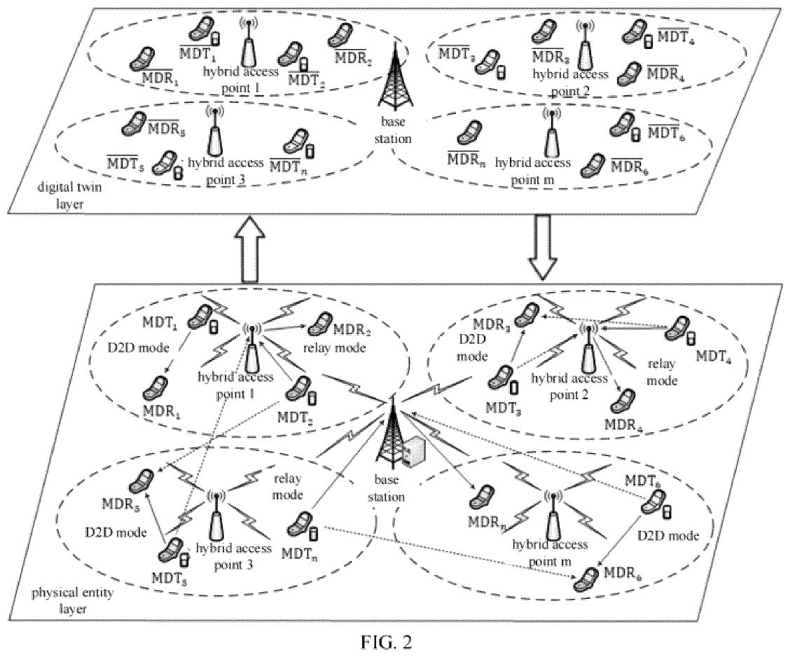

The energy harvesting mobile heterogeneous network optimization method with the age of information constraint proposed in the present disclosure can be applied to the application environment shown in FIG. 2. The energy harvesting mobile heterogeneous network includes a physical entity layer and a digital twin layer. The physical entity layer includes one multi-antenna base station, M multi-antenna hybrid access points, and N D2D device pairs (D2D pairs for short). Each D2D pair includes one D2D transmitter (MDT) and one D2D receiver (MDR), i.e., a transmitter and a receiver. The base station and the hybrid access points can transmit radio frequency (RF) signals for energy harvesting by the transmitter. The transmitter can select either a relay mode or a D2D mode to transmit data to its corresponding receiver. The wireless channel can be divided into Z sub-channels of equal bandwidth for the relay mode and the D2D mode.

The digital twin layer establishes a mapping between the physical entities in the physical entity layer and their corresponding digital twins in the digital twin layer, for storing state information of the physical entities and performing real-time information exchange. The digital twin layer is located in a digital twin server deployed at the base station. In FIG. 2, the digital twin server is shown adjacent to the base station.

Each transmitter in the network is equipped with a data buffer and generates data in each time slot with a certain probability. When the transmitter generates data in the current time slot, the data are stored in the buffer and the previously untransmitted data are discarded; Otherwise, the untransmitted data remain stored in the buffer. When the data in the data buffer is successfully transmitted, the AoI of the transmitter is reduced to the number of time slots elapsed since the successfully transmitted data was generated, and the throughput achieved by the transmitter is counted into the total network throughput in the current time slot. When the data transmission fails, the AoI of the transmitter increases by one, and the throughput achieved by the transmitter is not counted into the total network throughput in the current time slot.

Step S2: in a control phase of a time slot, moving the plurality of transmitters and the plurality of receivers; inputting, by the plurality of transmitters, local state information into a trained first deep reinforcement learning network to obtain a corresponding mode selection and channel allocation strategy; and sending the corresponding mode selection and channel allocation strategy to the digital twin layer.

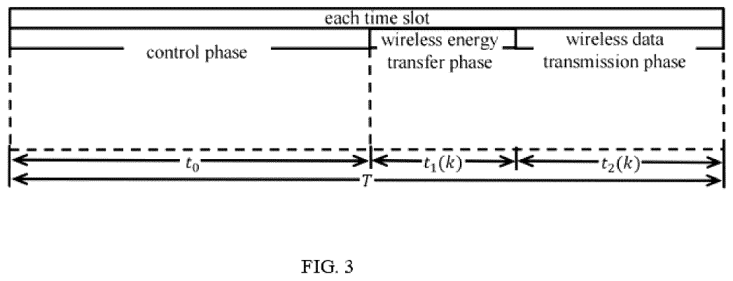

As shown in FIG. 3, each time slot includes a control phase with duration to, a wireless energy transfer phase with duration t₁(k), and a wireless data transmission phase with duration t₂(k).

In the network, all the hybrid access points, transmitters, and receivers follow static Poisson point distribution. The N transmitters and receivers move according to a Gauss-Markov random model in the control phase.

In the time slot k, the speed

$${v}_{n}^{Tr} ( k )$$

and direction

$${θ}_{n}^{Tr} ( k )$$

of transmitter n are updated as follows:

$${v}_{n}^{Tr} ( k ) = {κ}_{1} {v}_{n}^{Tr} ( k - 1 ) + ( 1 - {κ}_{1} ) \overline{v} + {Λ}_{n} \sqrt{( 1 - {κ}_{1}^{2} )}$$

$${θ}_{n}^{Tr} ( k ) = {κ}_{2} {θ}_{n}^{Tr} ( k - 1 ) + ( 1 - {κ}_{2} ) \overline{{θ}_{n}^{Tr}} + {Γ}_{n} \sqrt{( 1 - {κ}_{2}^{2} )}$$

wherein k₁ represents the constant used to adjust the influence of the velocity of the previous time slot on the velocity of the current time slot; k₂ represents the constant used to adjust the influence of the direction of the previous time slot on the direction of the current time slot; v̅ represents the average velocity of the transmitter and receiver;

$$\overline{{θ}_{n}^{Tr}}$$

represents the average direction of the transmitter n: Λₙ follows the independent Gaussian distribution with a mean-variance pair of

$$( {\overline{ξ}}_{{v}_{n}^{Tr}} , {\overline{ϛ}}_{{v}_{n}^{Tr}} ) ,$$

and Γₙ follows the independent Gaussian distribution with a mean-variance pair of

$$( {\overline{ξ}}_{{θ}_{n}^{Tr}} , {\overline{ϛ}}_{{θ}_{n}^{Tr}} ) .$$

In the time slot k, the position coordinate of the transmitter n are updated as follows:

$${x}_{n}^{Tr} ( k ) = {x}_{n}^{Tr} ( k - 1 ) + {v}_{n}^{Tr} ( k - 1 ) cos ( {θ}_{n}^{Tr} ( k - 1 ) ) {t}_{move}$$

$${y}_{n}^{Tr} ( k ) = {y}_{n}^{Tr} ( k - 1 ) + {v}_{n}^{Tr} ( k - 1 ) sin ( {θ}_{n}^{Tr} ( k - 1 ) ) {t}_{move}$$

wherein tₘₒᵥₑ represents the movement time of the transmitter and receiver in the control phase.

The digital twin layer and the physical entity layer perform twin communication, and the state information stored by the digital twin corresponding to each physical entity in the digital twin layer is updated. Each transmitter obtains its corresponding mode selection and channel allocation strategy by inputting its local state information into the trained first deep reinforcement learning network, and sends the obtained strategy to the digital twin layer through twin communication.

In the time slot k, the local state information of the transmitter n is defined as follows:

$${s}_{n} ( k ) = \{ {x}_{n}^{Tr} ( k ) , {y}_{n}^{Tr} ( k ) , {x}_{n}^{Re} ( k ) , {y}_{n}^{Re} ( k ) , \\ {s}_{n}^{a} ( k ) , {δ}_{n} ( k ) , {s}_{n}^{g} ( k ) , {s}_{n}^{h , R} ( k ) , {s}_{n}^{h , D} ( k ) , {s}_{W} ( k - 1 ) , {s}_{c} ( k - 1 ) \}$$

wherein

$${x}_{n}^{Tr} ( k ) and {y}_{n}^{Tr} ( k )$$

represent the position coordinates of the transmitter n after movement in time slot

$$k ; {x}_{n}^{Re} ( k ) and {y}_{n}^{Re} ( k )$$

represent the position coordinates of the receiver n after movement in time slot k;

$${s}_{n}^{a} ( k )$$

represents the ratio of the available energy to the battery capacity of the transmitter n at the beginning of time slot k; δₙ(k) represents the AoI of the transmitter n in time slot k;

$${s}_{n}^{g} ( k )$$

represents the binary variable indicating whether the transmitter n generates data in time slot k;

$${s}_{n}^{g} ( k ) = 1$$

indicates that the transmitter n generates data in time slot k, and

$${s}_{n}^{g} ( k ) = 0$$

indicates that the transmitter n does not generate data in time slot k;

$${s}_{n}^{h , R} ( k )$$

represents the channel gain between the transmitter n after movement and its associated base station or hybrid access point in time slot k;

$${s}_{n}^{h , D} ( k )$$

represents the channel gain between the transmitter n after movement and the receiver n after movement in time slot k; s_{W}(k−1)={W₁(k−1), . . . , W_{N}(k−1)} represents the throughput of transmitters in time slot (k−1); and

$${s}_{c} ( k - 1 ) = \{ {a}_{1 , d}^{ch} ( k - 1 ) , … , {a}_{N , d}^{ch} ( k - 1 ) \}$$

represents the channel allocation of transmitters in time slot (k−1).

In time slot k, the mode selection and channel allocation strategy of the transmitter n is defined as follows:

$${a}_{n , d} ( k ) = \{ {a}_{n , d}^{mo} ( k ) , {a}_{n , d}^{ch} ( k ) \}$$

wherein

$${a}_{n , d}^{mo} ( k )$$

represents the mode selection of the transmitter n in time slot k;

$${a}_{n , d}^{mo} ( k ) = 1$$

indication that the transmitter n selects the D2D mode in time slot k; and

$${a}_{n , d}^{mo} ( k ) = 0$$

indicates that the transmitter n selects the relay mode in time slot k; and

$${a}_{n , d}^{ch} ( k )$$

represents the channel index allocated to the transmitter n in time slot k.

Step S3: inputting, by the base station, global state information and the mode selection and channel allocation strategy of the plurality of transmitters into a trained second deep reinforcement learning network to obtain a power control and energy harvesting time strategy of the plurality of transmitters, and sending the power control and energy harvesting time strategy to the digital twin layer.

The transmitter and receiver remain stationary in the wireless energy transfer phase and wireless data transmission phase of each time slot.

The base station inputs the global state information together with the mode selection and channel allocation strategy of N transmitters into the trained second deep reinforcement learning network, to obtain the power control and energy harvesting time strategy of N transmitters, and sends the obtained strategy to the digital twin layer through twin communication.

In time slot k, the global state information and the mode selection and channel allocation strategy of N transmitters are defined as follows:

$${s}_{T} ( k ) = \{ {s}^{h} ( k ) , {s}_{c} ( k ) , {s}^{a} ( k ) , {s}^{δ} ( k ) , {s}_{W} ( k - 1 ) \}$$

wherein

$${s}^{h} ( k ) = \{ {s}_{1}^{h} ( k ) , … , {s}_{N}^{h} ( k ) \}$$

represents the channel gains between the transmitters after movement and the receivers determined by the mode selection with the first deep reinforcement learning network in time slot k;

$${s}_{c} ( k ) = \{ {a}_{1 , d}^{ch} ( k ) , … , {a}_{N , d}^{ch} ( k ) \}$$

represents the channel allocation (that corresponds to the channel allocation strategy) obtained from the first deep reinforcement learning network in time slot k.

$${s}^{a} ( k ) = \{ {s}_{1}^{a} ( k ) , … , {s}_{N}^{a} ( k ) \}$$

represents the rations of the available energy to the batter capacity of the transmitter at the beginning of the time slot k; s^{δ}(k)={δ₁(k), . . . , δ_{N}(k)} represents AoI of transmitters in time slot k; and s_{W}(k−1)={W₁(k−1), . . . , W_{N}(k−1)} represents the throughput of transmitters in time slot k−1.

Step S4: combining, by the digital twin layer, the mode selection and channel allocation strategy of the plurality of transmitters with the power control and energy harvesting time strategy of the plurality of transmitters into a complete mode selection and resource allocation strategy, and synchronizing the complete mode selection and resource allocation strategy to the plurality of transmitters.

The digital twin layer combines the mode selection and channel allocation strategy of N transmitters with the power control and energy harvesting time strategy of N transmitters into a complete mode selection and resource allocation strategy, and synchronizes it to N transmitters.

In time slot k, the mode selection and channel allocation strategy of N transmitters is defined as follows:

$${a}_{d} ( k ) = \{ {a}_{1 , d} ( k ) , … , {a}_{N , d} ( k ) \}$$

In time slot k, the power control and energy harvesting time strategy of N transmitters is defined as follows:

$${a}_{c} ( k ) = \{ {a}_{1 , c}^{e} ( k ) , … , {a}_{N , c}^{e} ( k ) , α ( k ) \}$$

wherein

$${a}_{n , c}^{e} ( k )$$

represents the ration of the energy consumed by the transmitter n for data transmission in time slot k to the available energy of the transmitter n at the beginning of the wireless data transmission phase in time slot k; and a (k) represents the ratio of the energy harvesting time of the transmitter to the sum of the wireless energy transfer phase and the wireless data transmission phase in time slot k.

In time slot k, the digital twin layer combines the mode selection and channel allocation strategy of N transmitters with the power control and energy harvesting time strategy of N transmitters into a complete mode selection and resource allocation strategy, defined as:

$$a ( k ) = \{ {a}_{d} ( k ) , {a}_{c} ( k ) \}$$

Step S5: in a wireless energy transfer phase, performing, by the plurality of transmitters, energy harvesting according to an energy harvesting time; and in a wireless data transmission phase, performing, by the plurality of transmitters, data transmission according to a mode selection, a channel allocation, and a power control.

The transmitter and receiver remain stationary in the wireless energy transfer phase and wireless data transmission phase of each time slot.

In the wireless energy transfer phase, N transmitters perform energy harvesting based on the energy harvesting time obtained from the complete mode selection and resource allocation strategy.

In the wireless data transmission phase, N transmitters perform corresponding data transmission based on the mode selection, channel allocation, and power control obtained from the complete mode selection and resource allocation strategy.

In another embodiment, the training process for deep reinforcement learning, namely, training the first deep reinforcement learning and the second deep reinforcement learning, is described. The training process includes the following steps:

step F1: initializing a local Q-network and a target Q-network corresponding to the first deep reinforcement learning network; and initializing parameters of a current actor network, a target actor network, a first current critic network, a first target critic network, a second current critic network, and a second target critic network corresponding to the second deep reinforcement learning network.

Specifically, the network parameters initialized of each agent in the first deep reinforcement learning network, include the parameter θₙ of the local Q network, and the parameter θ'ₙ of the target Q network. The parameters initialized of the second deep reinforcement learning network, include the parameter θ_{μ} of the current actor network, the parameter θ'_{μ} of the target actor network, the parameter θ_{c1} of the first current critic network, the parameter θ'_{c1} of the first target critic network, the parameter θ_{c2} of the second current critic network and the parameter θ_{c2} of the second target critic network. The total rounds of training iterations is EP, the total number of time slots in each iteration round is initialized to be K, and the iteration round is set to be ep=1.

step F2: initializing the plurality of hybrid access points, the plurality of transmitters, and the plurality of receivers.

The distribution of the hybrid access points, transmitters and receivers in the physical entity layer is initialized. The available energy in the transmitter battery is 0, the throughput is 0, and the AoI is 1. The data is generated according to probability, and the time slot in the iteration round is set to be k=1.

step F3: moving the plurality of transmitters and the plurality of receivers; and updating the local state information of a current time slot in the digital twin layer.

N transmitters and receivers move according to the Gauss-Markov random model. The digital twin layer and the physical entity layer perform twin communication, and the state information stored in the digital twin corresponding to the physical entity in the digital twin layer is updated.

Each transmitter receives the local state information sₙ(k) of the current time slot stored in its own digital twin from the digital twin layer.

step F4: sending, by the plurality of transmitters, the local state information to the local Q-network to obtain the corresponding mode selection and channel allocation strategy; and sending the mode selection and channel allocation strategy to the digital twin layer.

Each transmitter uses sₙ(k) as the input of the local Q network, which outputs corresponding actions a_{n,d}(k), namely mode selection and channel allocation strategy, and sends them to the digital twin layer via twin communication. The digital twin layer stores the mode selection and channel allocation strategy of N transmitters.

step F5: receiving, by the base station, the global state information in the digital twin layer and the mode selection and channel allocation strategy of the plurality of transmitters; inputting the global state information and the mode selection and channel allocation strategy into the current actor network to obtain the power control and energy harvesting time strategy of the plurality of transmitters; and sending the power control and energy harvesting time strategy to the digital twin layer.

The base station receives the global state information and the mode selection and channel allocation strategy S_{T}(k) of N transmitters stored by the corresponding digital twin in the digital twin layer. The base station uses s_{T}(k) as the input of the current actor network and outputs actions a_{c}(k), namely the power control and energy harvesting time strategy of transmitters, and sends them to the digital twin layer through twin communication.

step F6: combining, by the digital twin layer, the mode selection and channel allocation strategy of the plurality of transmitters with the power control and energy harvesting time strategy of the plurality of transmitters into the complete mode selection and resource allocation strategy, and synchronizing the mode selection and resource allocation strategy to the plurality of transmitters.

The digital twin layer combines a_{d}(k)={a_{1,d}(k), . . . , a_{N,d}(k)} and a_{c}(k) into the complete mode selection and resource allocation strategy a(k) and synchronizes it to N transmitters.

step F7: executing, by the plurality of transmitters, the complete mode selection and resource allocation strategy.

After receiving a(k), N transmitters extract it to obtain the mode selection and resource allocation strategy relevant to themselves. N transmitters first harvest energy in the wireless energy transfer phase of time slot k based on the energy harvesting time specified in a(k). In the wireless data transmission phase of the time slot k, data then is transmitted according to the mode selection, channel allocation, and power control.

step F8: calculating respectively, by the plurality of transmitters and the base station, corresponding rewards.

In the control phase of time slot (k+1), N transmitters and the base station acquire relevant state information via twin communication. The transmitter n calculates the corresponding reward rₙ(k) based on the throughput and AoI achieved in the time slot k, and rₙ(k) is calculated using the following formula:

$${r}_{n} ( k ) = {ω}_{W} {W}_{n} ( k ) - {ω}_{A} {χ}_{n} ( k )$$

wherein ω_{W} represents the weight of throughput; Wₙ(k) represents the throughput achieved by the transmitter n in time slot k; ω_{A} represents the weight of AoI; Xₙ(k) represents the AoI-related penalty for the transmitter n in the time slot k. When the AoI of the transmitter n in time slot k is less than the maximum tolerance threshold, Xₙ(k)=0; otherwise, Xₙ(k)=C_{X}e^{ξ(δ}^{ₙ}^{(k)-δ}^{ₘₐₓ}⁾, wherein c_{X} represents the positive constant that balances the order of magnitude; and δₘₐₓ represents the maximum tolerance threshold. The base station calculates the corresponding reward r(k) based on the rewards of N transmitters, and r(k) is calculated using the following formula:

$$r ( k ) = {\sum }_{n = 1}^{N} {r}_{n} ( k )$$

step F9: storing respectively, by the plurality of transmitters and the base station, experiences of the plurality of transmitters and the base station into respective experience replay pools; and sampling randomly, by the plurality of transmitters and the base station, a preset number of experiences.

Each transmitter stores its own experience (sₙ(k),a_{n,d}(k),rₙ(k),sₙ(k+1)) in time slot k in its own experience replay pool and randomly samples Nₘ experiences, wherein Sₙ(k) represents the local state information of the transmitter n in time slot k; a_{n,d}(k) represents the mode selection and channel allocation strategy for sₙ(k) in time slot k; rₙ(k) represents the reward received by the transmitter n in time slot k; and sₙ(k+1) represents the local state information of the transmitter n in time slot (k+1).

The base station stores the experience (S_{T}(k),a_{C}(k),r(k),S_{T}(k+1)) of time slot k in its own experience replay pool and randomly samples Nₘ experiences, wherein S_{T}(k) represents the local state information and the mode selection and channel allocation strategy of N transmitters in time slot k; a_{c}(k) represents the power control and energy harvesting time strategy of N transmitters for s_{T}(k) in time slot k; r(k) represents the reward received by the base station in time slot k; and s_{T}(k+1) represents the local state information and the mode selection and channel allocation strategy of N transmitters in time slot (k+1).

step F10: updating, by the plurality of transmitters, a parameter of the local Q-network based on sampled experiences.

Each transmitter updates the local Q network parameters based on the randomly selected Nₘ experiences according to formulas (1)-(3).

$${y}_{n}^{i} ( k ) = {r}_{n}^{i} ( k ) + γ {Q}^{′} ( {s}_{n}^{i} ( k + 1 ) , {max}_{a ∈ A} Q ( {s}_{n}^{i} ( k + 1 ) , a ; {θ}_{n} ) ; {θ}_{n}^{′} ) \qquad ( 1 )$$

$$L ( {θ}_{n} ) = \frac{1}{{N}_{m}} {{\sum }_{i = 1}^{{N}_{m}} [ {y}_{n}^{i} ( k ) - Q ( {s}_{n}^{i} ( k ) , {a}_{n , d}^{i} ( k ) ; {θ}_{n} ) ]}^{2} \qquad ( 2 )$$

$${θ}_{n} ← {θ}_{n} - β {∇}_{{θ}_{n}} L ( {θ}_{n} ) \qquad ( 3 )$$

wherein

$${y}_{n}^{i} ( k )$$

represents the target Q-value of the time slot corresponding to the experience i of the transmitter n; γ represents the discount factor;

$${max}_{a ∈ A} Q ( {s}_{n}^{i} ( k + 1 ) , a ; {θ}_{n} )$$

represents the action that maximizes the estimated Q-value of the Q-network of the transmitter n in the next time slot corresponding to the experience i;

$${Q}^{′} ( {s}_{n}^{i} ( k + 1 ) , {max}_{a ∈ A} Q ( {s}_{n}^{i} ( k + 1 ) , a ; {θ}_{n} )$$

represents the estimated Q-value of the target Q-network corresponding to the state information and action in the next time slot of the experience i of the transmitter n; L(θₙ) represents the loss function of the Q-network of the transmitter n; β represents the learning rate; ∇_{θ}_{ₙ}L(θₙ) represents the derivative of L (θₙ) with respect to θₙ; and i represents the i-th experience sample of the Nₘ-size experience samples randomly selected by the transmitter n.

step F11: performing a null operation when a current iteration number modulo 2 is not equal to zero; otherwise, updating a parameter of the target Q-network using the parameter of the local Q-network.

When a current iteration number modulo 2 is not equal to zero, no operation is performed; otherwise, the transmitter n updates the target Q-network parameter as \dot{θ}ₙ←θₙ.

step F12: updating, by the base station, the parameters of the first and second current critic networks based on sampled experiences.

The base station updates the parameter of the current critic network based on the randomly selected Nₘ experiences according to formulas (4)-(8).

$${y}^{i} ( k ) = {min}_{j = 12} \{ {r}^{i} ( k ) + γ {Q}_{j}^{′} ( {s}_{T}^{i} ( k + 1 ) , {a}_{c}^{i} ( k + 1 ) ; {θ}_{cj}^{′} ) \} \qquad ( 4 )$$

$${L}_{c 1} ( {θ}_{c 1} ) = \frac{1}{{N}_{m}} {{\sum }_{i = 1}^{{N}_{m}} [ {y}^{i} ( k ) - {Q}_{1} ( {s}_{T}^{i} ( k ) , {a}_{c}^{i} ( k ) ; {θ}_{c 1} ) ]}^{2} \qquad ( 5 )$$

$${L}_{c 2} ( {θ}_{c 2} ) = \frac{1}{{N}_{m}} {{\sum }_{i = 1}^{{N}_{m}} [ {y}^{i} ( k ) - {Q}_{2} ( {s}_{T}^{i} ( k ) , {a}_{c}^{i} ( k ) ; {θ}_{c 2} ) ]}^{2} \qquad ( 6 )$$

$${θ}_{c 1} ← {θ}_{c 1} - {β}_{c} {∇}_{{θ}_{c 1}} {L}_{c 1} ( {θ}_{c 1} ) \qquad ( 7 )$$

$${θ}_{c 2} ← {θ}_{c 2} - {β}_{c} {∇}_{{θ}_{c 2}} {L}_{c 2} ( {θ}_{c 2} ) \qquad ( 8 )$$

wherein y^{j}(k) represents the smaller value of the time difference error of the first and second current critic networks in the time slot corresponding to the experience i of the base station;

$${Q}_{j}^{′} ( {s}_{T}^{i} ( k + 1 ) , {a}_{c}^{i} ( k + 1 ) ; {θ}_{cj}^{′} )$$

represents the Q-value of the j-th (j ∈ {1,2}) target critic network of the state information in next time slot of the time slot corresponding to the experience i(j=1 corresponds to the first target critic network, j=2 corresponds to the second target critic network); L_{c1}(θ_{c1}) and L_{c2}(θ_{c2}) represent the loss functions of the first and second current critic networks respectively;

$${Q}_{1} ( {s}_{T}^{i} ( k ) , {a}_{c}^{i} ( k ) ; {θ}_{c 1} )$$

represents the Q-value of the first current critic network in the state information of the time slot corresponding to the experience i;

$${Q}_{2} ( {s}_{T}^{i} ( k ) , {a}_{c}^{i} ( k ) ; {θ}_{c 2} )$$

represents the Q-value of the second current critic network in the state information of the time slot corresponding to the experience i; ∇_{θ}_{_{c1}}L_{c1}(θ_{c1}) represents the derivative of L_{c1}(θ_{c1}) with respect to θ_{c1}; ∇_{θ}_{_{c2}}L_{c2}(θ_{c2}) represents the derivative of L_{c2}(θ_{c2}) with respect to θ_{c2}; and i represents the i-th experience in Nₘ experiences randomly sampled by the base station.

step F13: performing the null operation when the current iteration number modulo 2 is not equal to zero; otherwise, updating the parameters of the current actor network and all the target networks based on the sampled experiences.

When the current iteration number modulo 2 is not equal to zero, no operation is performed; otherwise, the parameters of the current actor network and all target networks are updated based on Nₘ experiences sampled by the base station according to formulas (9)-(13).

$${L}_{μ} ( {θ}_{μ} ) = \frac{1}{{N}_{m}} {\sum }_{i = 1}^{{N}_{m}} {Q}_{1} ( {s}_{T}^{i} ( k ) , {a}_{c}^{i} ( k ) ; {θ}_{c 1} ) \qquad ( 9 )$$

$${θ}_{μ} ← {θ}_{μ} + {β}_{μ} {∇}_{{θ}_{μ}} {L}_{μ} ( {θ}_{μ} ) \qquad ( 10 )$$

$${θ}_{μ}^{′} ← {τ}_{μ} {θ}_{μ} + ( 1 - {τ}_{μ} ) {θ}_{μ}^{′} \qquad ( 11 )$$

$${θ}_{c 1}^{′} ← {τ}_{c} {θ}_{c 1} + ( 1 - {τ}_{c} ) {θ}_{c 1}^{′} \qquad ( 12 )$$

$${θ}_{c 2}^{′} ← {τ}_{c} {θ}_{c 2} + ( 1 - {τ}_{c} ) {θ}_{c 2}^{′} \qquad ( 13 )$$

wherein τ_{μ} represents the soft updating factor of the actor network and τ_{c} represents the soft updating factor of the critic network.

step F14: setting a next time slot as the current time slot and returning to the step F3 when a current time slot number is less than a total number of time slots.

If the current time slot satisfies k<K, updating k=k+1 and returning to the step F3, wherein K represents the total number of time slots.

step F15: returning to the step F2 to continue iterative training when a current iteration number is less than a total iteration number; otherwise, ending the training.

If k≥K and ep<EP, ending one iteration, updating ep=ep+1 and returning to the step F2; if k=K and ep=EP, ending the training.

It should be noted that after training, the obtained parameter of the local Q-network is the parameter of the trained first deep reinforcement learning network, and the obtained parameter of the current actor network is the parameter of the second deep reinforcement learning network, which is used for energy harvesting mobile heterogeneous network optimization with the age of information constraint.

The embodiments described above represent only several implementations of the present disclosure. Although the description is relatively specific and detailed, it should not be construed as limiting the scope of the present disclosure. It should be noted that those of ordinary skill in the art may make various modifications and improvements without departing from the concept of the present disclosure, and these all fall within the protection scope of the present disclosure. Therefore, the protection scope of this present disclosure should be subject to the appended claims.

What is claimed is:

1. An energy harvesting mobile heterogeneous network optimization method with an age of information constraint, wherein the energy harvesting mobile heterogeneous network optimization method with the age of information constraint comprises steps of:
establishing a corresponding digital twin layer for a physical entity layer comprising a base station, a plurality of hybrid access points, a plurality of transmitters, and a plurality of receivers;
in a control phase of a time slot, moving the plurality of transmitters and the plurality of receivers; inputting, by the plurality of transmitters, local state information into a trained first deep reinforcement learning network to obtain a corresponding mode selection and channel allocation strategy; and sending the corresponding mode selection and channel allocation strategy to the digital twin layer;
inputting, by the base station, global state information and the mode selection and channel allocation strategy of the plurality of transmitters into a trained second deep reinforcement learning network to obtain a power control and energy harvesting time strategy of the plurality of transmitters, and sending the power control and energy harvesting time strategy to the digital twin layer;
combining, by the digital twin layer, the mode selection and channel allocation strategy of the plurality of transmitters with the power control and energy harvesting time strategy of the plurality of transmitters into a complete mode selection and resource allocation strategy, and synchronizing the complete mode selection and resource allocation strategy to the plurality of transmitters; and
in a wireless energy transfer phase, performing, by the plurality of transmitters, energy harvesting according to an energy harvesting time; and in a wireless data transmission phase, performing, by the plurality of transmitters, data transmission according to a mode selection, a channel allocation, and a power control,
wherein the local state information comprises:
a position coordinate of a corresponding transmitter after movement in a current time slot; a position coordinate of a corresponding receiver after movement in the current time slot; a ratio of available energy to a battery capacity of the corresponding transmitter at a beginning of the current time slot; an age of information of the corresponding transmitter in the current time slot; a binary variable indicating whether the corresponding transmitter generates data in the current time slot; a channel gain between the corresponding transmitter after movement and an associated base station or an associated hybrid access point in the current time slot; a channel gain between the corresponding transmitter after movement and the corresponding receiver after movement in the current time slot; a throughput of the plurality of transmitters in a previous time slot; and a channel allocation of the plurality of transmitters in the previous time slot, and
wherein the global state information comprises:
a ratio of available energy to a battery capacity of the plurality of transmitters at the beginning of the current time slot; an age of information of the plurality of transmitters in the current time slot; and a throughput of the plurality of transmitters in the previous time slot.

2. The energy harvesting mobile heterogeneous network optimization method with the age of information constraint according to claim 1, wherein the digital twin layer is deployed at the base station.

3. The energy harvesting mobile heterogeneous network optimization method with the age of information constraint according to claim 1, wherein the energy harvesting mobile heterogeneous network optimization method with the age of information constraint further comprises a step of:
training the first deep reinforcement learning network and the second deep reinforcement learning network,
wherein the step of training the first deep reinforcement learning network and the second deep reinforcement learning network comprises steps of:
step F1: initializing a local Q-network and a target Q-network corresponding to the first deep reinforcement learning network; and initializing parameters of a current actor network, a target actor network, a first current critic network, a first target critic network, a second current critic network, and a second target critic network corresponding to the second deep reinforcement learning network;
step F2: initializing the plurality of hybrid access points, the plurality of transmitters, and the plurality of receivers;
step F3: moving the plurality of transmitters and the plurality of receivers; and updating the local state information of a current time slot in the digital twin layer;
step F4: sending, by the plurality of transmitters, the local state information to the local Q-network to obtain the corresponding mode selection and channel allocation strategy; and sending the mode selection and channel allocation strategy to the digital twin layer;
step F5: receiving, by the base station, the global state information in the digital twin layer and the mode selection and channel allocation strategy of the plurality of transmitters; inputting the global state information and the mode selection and channel allocation strategy into the current actor network to obtain the power control and energy harvesting time strategy of the plurality of transmitters; and sending the power control and energy harvesting time strategy to the digital twin layer;
step F6: combining, by the digital twin layer, the mode selection and channel allocation strategy of the plurality of transmitters with the power control and energy harvesting time strategy of the plurality of transmitters into the complete mode selection and resource allocation strategy, and synchronizing the mode selection and resource allocation strategy to the plurality of transmitters;
step F7: executing, by the plurality of transmitters, the complete mode selection and resource allocation strategy;
step F8: calculating respectively, by the plurality of transmitters and the base station, corresponding rewards;
step F9: storing respectively, by the plurality of transmitters and the base station, experiences of the plurality of transmitters and the base station into respective experience replay pools; and sampling randomly, by the plurality of transmitters and the base station, a preset number of experiences;
step F10: updating, by the plurality of transmitters, a parameter of the local Q-network based on sampled experiences;
step F11: performing a null operation when a current iteration number modulo 2 is not equal to zero; otherwise, updating a parameter of the target Q-network using the parameter of the local Q-network;
step F12: updating, by the base station, the parameters of the first and second current critic networks based on sampled experiences;
step F13: performing the null operation when the current iteration number modulo 2 is not equal to zero; otherwise, updating the parameters of the current actor network and all the target networks based on the sampled experiences;
step F14: setting a next time slot as the current time slot and returning to the step F3 when a current time slot number is less than a total number of time slots; and
step F15: returning to the step F2 to continue iterative training when a current iteration number is less than a total iteration number; otherwise, ending the training.

4. The energy harvesting mobile heterogeneous network optimization method with the age of information constraint according to claim 3, wherein the experiences of the plurality of transmitters comprise the local state information of the plurality of transmitters, the mode selection and channel allocation strategy, the rewards obtained by the plurality of transmitters, and the local state information of the plurality of transmitters in the next time slot.

5. The energy harvesting mobile heterogeneous network optimization method with the age of information constraint according to claim 3, wherein the experiences of the base station comprise the global state information, the mode selection and channel allocation strategy of the plurality of transmitters, the power control and energy harvesting time strategy of the plurality of transmitters, the reward obtained by the base station, as well as the global state information and the mode selection and channel allocation strategy of the plurality of transmitters in the next time slot.
